(19) United States
(12) Patent Application Publication
(10) Pub. No.: US 2014/0013297 A1
(43) Pub. Date: Jan. 9, 2014

(54) Query-Based Software System Design Representation

(71) Applicants: Stephen Cook, Bishop's Stortford (GB); Stuart Kent, Canterbury (GB)

(72) Inventors: Stephen Cook, Bishop's Stortford (GB); Stuart Kent, Canterbury (GB)

(73) Assignee: Microsoft Corporation, Redmond, WA (US)

(21) Appl. No.: 13/541,278

(22) Filed: Jul. 3, 2012

(51) Int. Cl. G06F 9/44

(52) U.S. Cl. 717/105

(57) ABSTRACT

A computer-implemented method for providing a design representation of a software system includes storing in a memory a dataset representative of a plurality of software code elements of the software system, wherein storing the dataset includes incorporating design data into the dataset, the design data being representative of respective design properties regarding the software code elements. A dataset query including a reference to an item of the dataset is received. The dataset query is implemented, with a processing unit in communication with the memory, over the dataset. Implementing the dataset query includes defining a subset of the dataset based on the reference to the item. A user interface rendered via an output device in communication with the processing unit user interface includes a view of the design representation of the software system in accordance with the defined subset of the dataset.

### BACKGROUND OF THE DISCLOSURE

The development of software systems is often accompanied by efforts to maintain design documentation or models of the software code. Such efforts attempt to provide insight into the software code beyond the information made available from comments inserted into the code, which are often limited to specifying the behavior of a declared function. Unfortunately, maintaining design documentation is challenging during the development of large software systems, which may have millions of lines of code.

In object-oriented systems, large software systems may have thousands of objects. An object-oriented programming language, such as C#, may allow software developers to document the code by assigning attributes to objects. The resulting documentation is accordingly limited to referencing elements in the software code itself.

Graphical modeling tools have been used to document the interactions and relationships between the objects. Some graphical modeling tools are based on the Unified Modeling Language (UML). Unfortunately, these and other approaches to maintaining design documentation remain too costly, time consuming, and/or prone to error as changes to code occur during development.

### SUMMARY OF THE DISCLOSURE

Methods and systems are directed to providing design information for software systems. The design information is provided via queries implemented over a dataset in which elements of the software system are stored in connection with additional information regarding the software system, including, for example, design abstractions and design annotations. The results of the queries are provided via a user interface that presents a representative view, slice, or other subset of the dataset. Additional design information may then be overlaid on, or otherwise integrated into, the representative view. The additional design information may include, for example, system performance data and/or design validation data.

In accordance with one aspect of the disclosure, a view of a design representation of a software system may be provided in accordance with a dataset query. Design data is incorporated into a dataset representative of a plurality of software code elements of the software system. The dataset query is implemented over the dataset to define a subset of the dataset rendered in the design representation view.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWING FIGURES

FIG. 1 is a block diagram of an exemplary system configured to provide a design representation of a software system in accordance with one embodiment.

FIG. 2 is a flow diagram of an exemplary computer-implemented method to provide a design representation of a software system in accordance with one embodiment.

FIGS. 3-14 are schematic illustrations of exemplary user interfaces generated or rendered via the disclosed methods and systems.

FIG. 15 is a block diagram of a computing environment in accordance with one embodiment for implementation of one or more of the disclosed methods and systems.

While the disclosed systems and methods are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION

The disclosed methods and systems are directed to providing design representations of software systems. The design representations may be provided via queries of a dataset of software code elements and design data for the software system. The query-based nature of the disclosed methods and systems allow the resulting design representations to be updated to reflect changes in the software system. The disclosed methods and systems may thus facilitate the ongoing documentation, analysis, exploration, understanding, development, and maintenance of software systems. For example, the disclosed methods and systems may be useful for developing a desired design for a software system, then validating that the code of the software system complies with the desired design, and/or determining where the code of the software system does not meet the desired design. A number of aspects of the disclosed methods and systems are directed to maintaining an up-to-date representation of the design.

The queries may be used to define a subset of the software system based on references to a variety of different code constructs, such as assemblies and namespaces. The subset may be based on references to build definitions or other constructs that define a collection of code. Such code constructs may be added to a code index dataset to be queried. Each subset-defining query may reference names, relationships, and other information regarding code elements and other design data in the code index dataset. The subsets thus correspond with views or slices through the code elements and other design data over which the query is run. Using the code constructs and other code elements of the software system in the queries may allow a software developer to avoid having to create corresponding layers, components, or other elements in a separate model of the software system. The queries may be configured as query expressions via a user interface (e.g., a text editor). The queries may be implemented and re-implemented to deliver and update the design representation of the software system.

The design representations provided by the disclosed methods and systems may be integrated with, rather than separated from, the underlying software code. Such integration allows the design representation to be updated as changes to the underlying code occur. As described below, the updates may be provided in an automated manner by re-implementing a dataset query. Past queries may be persisted or otherwise made available to this end. Additional efforts to synchronize the design representation with the code are avoided. The disclosed methods and systems may thus provide a live or running documentation of the underlying code.

The integration of the disclosed methods and systems with the software system may also avoid the repetition of information already present in the software code. Such information may then be complemented (rather than merely repeated) by additional design information as described below. The design representation may thus integrate design data from multiple sources. For example, the design representation may thus avoid being limited to certain types of design elements, such as UML design elements. Forced translation of design information into a specific format (e.g., UML format) may also be avoided.

While integration with the software system provides a number of benefits, the disclosed methods and systems may nonetheless be useful regardless of whether access to the source code underlying the software system is available. The disclosed methods and systems need not maintain continued or other access to, or availability of, the underlying source code. A code index dataset may be updated on a build, or when a query is submitted and a determination is made that the code index dataset is not up to date. In some cases, structural information regarding the software system may be extracted from binary files compiled from source code. In other cases, structural information regarding the software system may be extracted directly from source code.

The queries of the disclosed methods and systems are not limited to references to items in the code itself. The dataset over which the queries are implemented may include design data other than source code or code elements derived therefrom. As described herein, user interfaces of the disclosed methods and systems may be configured to support the entry, storage, and eventual use of such additional design data. Alternatively or additionally, the disclosed methods and systems may be configured to support the automated extraction or generation of such additional design data via analysis of the code elements.

Design annotations are one example of additional design data incorporated for use in the design representation of the software system. Design annotations may be directed to specifying layers or dependencies for code elements of the software system. The design annotations may then be referenced in a query to find the code elements associated with the layer. Annotations are not limited to specifying layers and dependencies, and may be used to represent a variety of aspects of the software system. For example, annotations may represent components of a software model framework in which, for instance, contracts between components of the software system are identified. Alternatively or additionally, annotations may be representative of (i) definitions of components of the software system, including, for instance, an indication of the boundaries of such components, (ii) types of dependencies between the components, and (iii) an indication of whether code elements are focal, ancillary, or incidental. Annotations may also be indicative of behavioral characteristics of the software system, including, for example, states of the software system and transitions between such states. The states may be connected to code through an annotation expression over properties and fields. Annotations in the disclosed methods and systems are thus not limited to explicitly referencing code elements.

The disclosed methods and systems are not limited to design annotations provided via the user interfaces of the disclosed methods and systems. The incorporation of design data may be facilitated by an automated extraction of design information from the code elements. The design information may be present in a variety of forms. The disclosed methods and systems may be configured to apply abstraction functions to observe or detect software design patterns in the code, such as the patterns used in frameworks. The abstraction functions may be configured to incorporate references to design abstractions of the frameworks or other patterns into the design data in association with respective code elements.

The design annotations and design abstractions enhance the design representations generated by the disclosed methods and systems. The design representations may thus avoid mere redundant expression of information present in the code.

The design representations may be used for design documentation and/or validation. Validation procedures may be implemented in connection with the query-based designs of the software system to determine whether the software system meets one or more design policies or other criteria. The design policies may be established via the design annotations. An indication of where the software system meets, or fails to meet, a design policy or other criterion may be presented with the design representation view of the software system.

Software development may also be enhanced through the presentation of performance data with the design representation view of the software system. Such performance data may include data directed to software metrics, runtime data (e.g., operational performance), management (e.g., bug count) and other data. The performance data may be presented with the design representation of the current or live build of the software system. The performance data may be overlaid or otherwise integrated with the presentation of the design information.

Although described in the context of several examples of object-oriented software code, the disclosed methods and systems may be used with a wide variety of source code languages and frameworks. The disclosed methods and systems are not limited to software systems based upon any particular scheme, framework, or technology. As described below, the disclosed methods and systems may be configured with one or more modules for importing additional code constructs and other information to support such other languages, schemes, frameworks, or technologies.

The disclosed methods and systems may be implemented in connection with an integrated development environment (IDE) system. One example of an IDE system in which the user interfaces and other functionality of the disclosed methods and systems may be integrated is the IDE system presented by the Microsoft® Visual Studio® product family commercially available from Microsoft Corporation (Redmond, Wash.). While well suited for use in that IDE system, practice of the disclosed methods and systems is not limited to any particular IDE system, methodology, framework, or scheme.

The views of the design representation provided by the disclosed methods and systems may correspond with a subset of a code index dataset. The subset may thus include code elements and any other design data in the code index dataset. As described below, other design data may include design annotations and design abstractions. The subset may be defined by a dataset query, which may specify search criteria via a number of different search terms or functions. Examples of search terms or functions include searching according to container type (e.g., assembly, namespace, type, and other code element properties), name (including wildcards), and relationships (e.g., inheritance). The query may also include constructs, instructions, or terms configured to grouping and otherwise structuring the results. Dataset queries may thus be used to define a subset of the software system to be visualized, validated, or used as a working set.

Design annotations incorporated into the design data via the disclosed methods and systems may define additional facts about the software system. Design annotations may be specified as a property of one or more code elements of the software system. Design annotations need not be directly derived from the code. Design annotations may nonetheless be related to the code element(s) with which the design annotation is associated. Design annotations may be used to define or identify architectural components of the software system and other aspects of the design, as described herein.

Design abstractions incorporated into the design data via the disclosed methods and systems may also define additional facts about the software system not directly represented in the code. Design abstractions may be generated by analyzing the code elements for design patterns. The analysis may be implemented in an automated manner via execution of an abstraction function configured to observe or detect a specific pattern. The analysis may be directed to design data other than the code itself. For example, annotations in the design data may provide information useful for identifying a design pattern. Design data indicative of the design abstractions resulting from the analysis may then be stored in the code index dataset for use in future queries. For example, a user interface for specifying annotations may be configured with constructs to allow a user to designate or accept certain design abstractions as accurate. The design abstractions are then stored in the code index dataset as further design data not directly derived from the code.

Design policies may correspond with and/or specify criteria or rules of an expected or desired design for the software system. The disclosed methods and systems may be configured to facilitate the specification of one or more design policies and implementation of such policies to determine whether the software system conforms to the desired design criteria. As described below, design policies may be established via one or more design annotations indicative of the desired or expected design. For example, the desired design may be expressed via a dependency graph to be matched or met by the software system.

A number of exemplary embodiments are described below to illustrate the use of dataset queries to provide design representations of software systems. The queries are implemented against a dataset in which information indicative of the code elements is combined with other design data, such as user-specified design annotations and observed design abstractions. The results of the queries may be used to improve the dataset by defining further annotations to be incorporated therein. The queries may also be used to define subsets of the software system to be evaluated against design policies, which may be specified in the same manner as the design annotations. Such query-based design representation may be used to provide and/or support living design documentation, software system visualization, code validation, and other system evaluation.

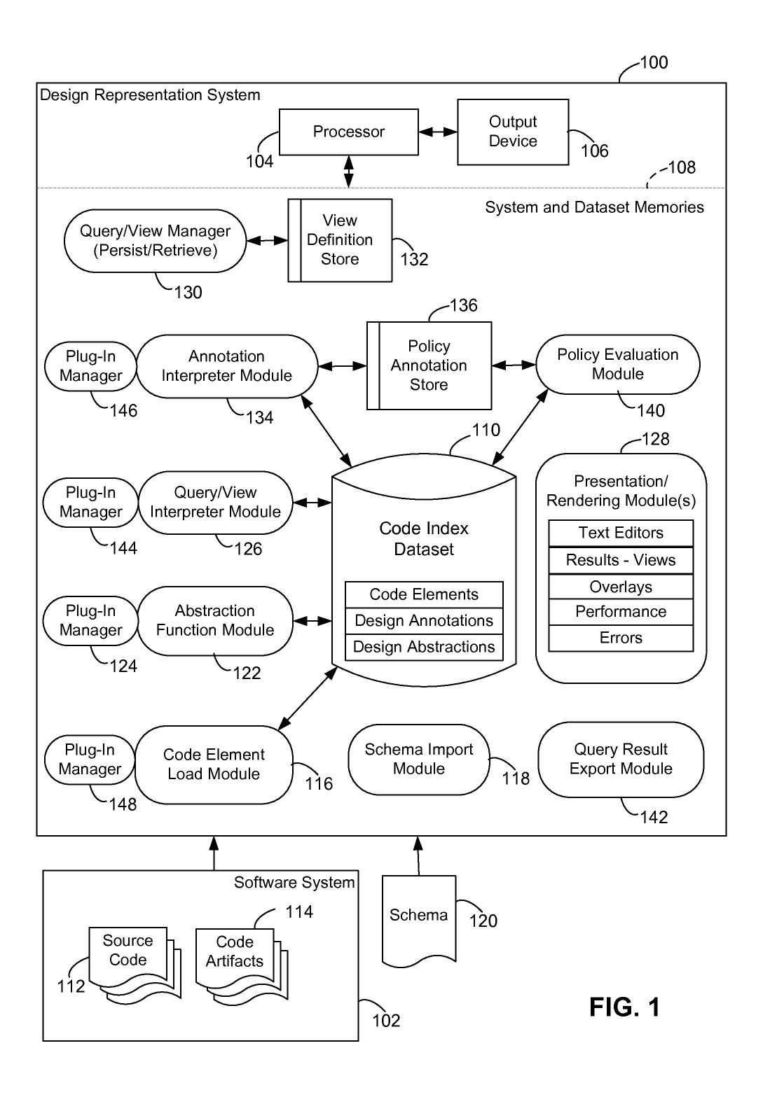

FIG. 1 depicts a system 100 configured to provide a design representation of a software system 102 in accordance with an exemplary embodiment. The system 100 includes a processor 104, an output device 106 coupled to the processor 104, and a number of storage devices or other memories 108 coupled to the processor 104. The memories 108 may include one or more dataset memories and one or more system memories. The dataset memories are directed to storing data used or generated during operation of the system 100. The system memories are directed to storing instructions implemented by the processor 104. The dataset and system memories may be disposed in or distributed over any number of devices, computers, or other data storage devices, and may be integrated to any desired extent. In this example, the memories 108 include a memory for a code index dataset 110 in which data representative of a plurality of software code elements of the software system 102 is stored. The code index dataset 110 may be provided via a shared memory made available for multiple users. The software code elements may be obtained from one or more source code files 112 or code artifact files 114 of the software system 102. The nature of the information presented in the code artifact files 114 may vary. For instance, the code artifact files 114 may include built artifacts or other data or information that may be deployed with the code, including, for example, reference data, resources, metadata, and style sheets. In other embodiments, code artifacts may be obtained from repositories other than files.

The code index dataset 110 includes design data beyond the source code or code artifacts. The design data is representative of respective design properties of the software code elements of the software system 102. As described further below, the design data in the code index dataset may also include data indicative of design annotations and design abstractions for the code elements of the software system 102. The design data may thus be indicative of the structure of the code and include information about abstractions determined from the structure. The code index dataset 110 may be configured as a database or any other persistent storage data structure that holds information about a software system. The code index dataset 110 may arrange the data stored therein in an indexed format in connection with predefined or previously used database queries. In other embodiments, the design data need not be stored in an indexed dataset or database.

The code index dataset 110 may include design data for multiple versions or builds of the software system 102. The system 100 may provide an opportunity to select a desired build or version via a user interface element, an example of which is described below.

The processor 104 is configured via the instructions in the system memory to implement one or more aspects of the disclosed methods and systems. The instructions may be arranged in a number of system modules. In this example, the system modules are stored in a single system memory of the memories 108. The architecture of the memories 108 may differ from the example shown. For example, the instructions for the system modules may be distributed over any number of system memories, computers, or other devices. In this example, instructions are provided for modules directed to importing or loading data from or related to the software system 102, including a code element load module 116 and a schema import module 118. The code element load module 116 is directed to receiving and/or obtaining data indicative of the source code 112 and/or the code artifact files 114, as well as loading such data into the code index dataset 110. The schema import module 118 is directed to importing data indicative of possible schema definitions 120 for the software system 102. The schema may include definitions to support the use of new constructs in the design representations provided by the system 100. For example, new schema may be incorporated into the memories 108 to configure the system 100 for storage of information specifying additional design abstractions, annotations, and/or programming languages or technologies. Such information may also be stored in one or more memories, files, or other storage media outside of the code index dataset 110.

Instructions are provided for analyzing the code elements in the code index dataset 110 to generate design data for use by the system 100. In this embodiment, analysis is implemented via an abstraction function module 122 configured to execute one or more abstraction operations on the code elements and/or artifacts in the code index dataset 110. The abstraction function(s) or operation(s) are configured to analyze the code index dataset 110 for instances of a software design pattern. For example, the software design pattern may be observed or detected in the code elements and/or artifacts by recognizing structures or attributes indicative of the software design pattern, parsing annotations for text indicative of the software pattern, and other analysis techniques. The analysis may implement a number of calculations over the code elements in the code index dataset 110. For example, in an exemplary analysis to discover dependency injections implemented using the Managed Extensibility Framework (MEF), the analysis may search for MEF import/export attributes (e.g., instances of attributes defined in the MEF namespace), and the parameters of such attributes, and then calculate what contracts are involved, what components are supplying, and what components are consuming. In a Ninject framework example, the calculations may identify those components representative of contracts, suppliers, and consumers. The calculations may be shared or used in more than one analysis technique.

For each detected instance of the software design pattern, the abstraction operation(s) may assign design abstractions to the corresponding code elements or artifacts in accordance with the pattern. For example, one abstraction operation may be configured to detect the code elements corresponding with the contracts, clients, and suppliers of a dependency injection pattern. The abstraction function analysis and subsequent storage of design abstraction information as design data may save the developer or other user from having to add design annotations manually for such abstractions. Further examples of abstraction functions and the corresponding design abstractions are set forth below.

Multiple abstraction functions may be supported. The software design patterns may correspond with the patterns used by a variety of different frameworks, such as the Managed Extensibility Framework (MEF), the model-view-controller (MVC) framework, and Ninject. Alternatively or additionally, the software design patterns may be reflective of an architectural approach such as Representational State Transfer (REST), or design patterns such as Gang of Four (GoF) patterns (State, Factory, and other creational, structural, or behavioral patterns). Respective abstraction functions may be provided to map the code elements or artifacts to corresponding design abstractions of the framework or architecture of the software design pattern. Information specifying the respective abstraction functions may be provided via plug-ins or other add-ons incorporated via, for instance, a plug-in manager 124 for the abstraction function module 122.

As described below, the plug-in manager 124 is one of a number of plug-in managers through which a variety of plug-ins may be incorporated into the system 100. Each plug-in may define or provide code or storage of information directed to extending the functionality of a component of the system 100. The plug-ins may be associated with one another. For example, multiple plug-ins may be incorporated as a group to incorporate a particular software design pattern or technology through each of the plug-in managers. The members of the group may share a number of common definitions or other data about the software design pattern or other technology.

Design data indicative of the design abstractions is then stored in the code index dataset 110. The design data may thus be configured to associate the software code element of each detected instance with a corresponding design abstraction of the software design pattern. Such design data may then be available for later use in providing the design representations of the software system 102.

Implementation of the abstraction module instructions by the processor 104 may be triggered by the loading of additional code elements into the code index dataset 110, or by some other event. Alternatively or additionally, the abstraction function analysis may be implemented upon loading of an additional abstraction function. In some embodiments, the analysis may be implemented in response to a user request via a user interface of the system 100.

The design data stored in the code index dataset 110 may be selectively retrieved to provide specific design representation views of the software system 102. The selection of the design data to be retrieved is specified via a dataset query entered via a user interface (e.g., a text editor) rendered by the system 100. The dataset query is implemented over the code index dataset 110 to define a subset of the code index dataset 110 to be provided in the design representation view. To this end, the dataset query may include a reference to a software design pattern or a corresponding design abstraction, or may specify a container type, an object name, or an object relationship. For example, a dataset query may be directed to finding all classes that export or supply a particular contract in a contract-supplier-client design pattern. The subset to be presented in the design representation view may then be limited to those code elements (or other design data) associated with the referenced software design pattern or design abstraction, or the specified container type, name, or relationship. The design representation view may present the subset in the terms, vocabulary, and/or concepts of the referenced pattern or abstraction.

Instructions for interpreting the dataset queries are set forth in an interpreter module 126 in the example of FIG. 1. The interpreter module 126 may be configured to interpret the dataset query and to implement the dataset query over the code index dataset 110. For example, the interpreter module 126 may be configured to generate a database query for the code index dataset 110 by parsing a textual expression of the dataset query to identify each term in the textual expression, evaluating the syntax of each term, implementing any functions or operations (e.g., logical or other operators such as “union”) recognized via the syntax, and other processing. The interpreter module 126 may then send the database query to the code index dataset 110 or otherwise query the code index dataset 110 in accordance with the database query.

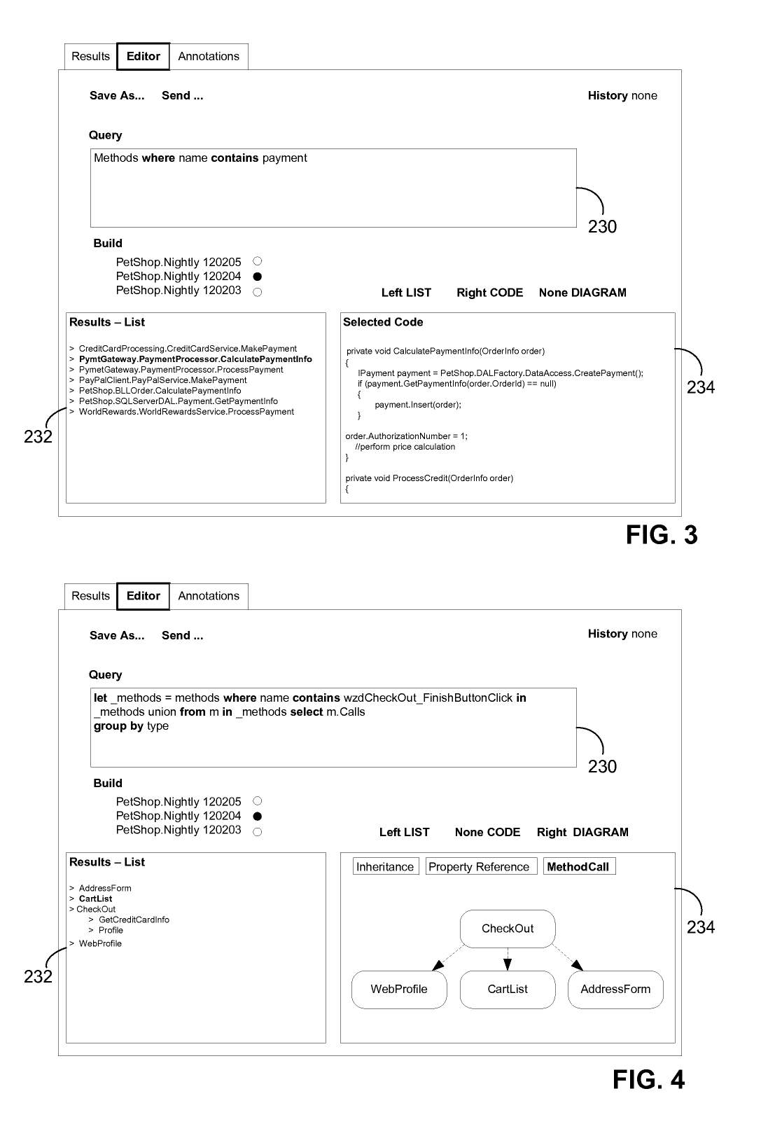

The interpreter module 126 may be configured in accordance with a query or view language in which the dataset queries are expressed. The syntax of the query language may vary. In one example, the query language may be defined via an XML (extensible markup language) structure. A number of exemplary queries are provided below in connection with FIGS. 3-6.

The interpretation and query language may include general operators, terms and components, as well as components specific to a particular technology, which may be introduced by a plug-in. For example, general terms may be provided for the overall expression structure (e.g., let, select, from, etc.), certain basic algebraic processing (e.g., Boolean, Integer, predicate logic, string processing), and for accessing properties of objects (e.g., dot notation). Specific terms may be provided to interpret particular types of objects (e.g., Assembly, Namespace, Type for CLR), additional properties onto existing types (e.g. IsContract as a new property for Type introduced by the Dependency Injection plugin), and standard named collections indicative of the entire data scope (e.g., assemblies=all assemblies in the selected build, or mvcapps=all the MVC Applications in the selected build).

The results of the dataset queries are presented via a user interface generated or rendered by the system 100. The user interface includes a view of the design representation of the software system 102 in accordance with the subset of the code index dataset 110 defined by the query. A presentation module 128 may provide instructions for the generation of the user interface. The presentation module 128 may direct the processor 104 to render, via the output device 104, the user interface. Instructions for the presentation module 128 may be set forth as a Windows Presentation Foundation (WPF) application, in accordance with an XML-oriented object model or other framework, or any kind of browser-related user interface technology or other user interface framework. The presentation module 128 may be configured to provide the query results via a wide variety of user interfaces and user interface elements. For example, the user interface may include various types of lists (e.g., code element lists, source code listings, etc.), various types of hierarchical representations (e.g., trees) and various graphical views (e.g., diagrams). A number of exemplary user interfaces are provided below in connection with FIGS. 3-14. The user interface may include any number of user interface elements. For instance, the selection of an element of one user interface may lead to the generation or rendering of a further user interface that reveals, for example, underlying source code for navigation thereof.

A history of past queries and query results or views may be persisted and retrieved via a query manager 130. Data indicative of the past queries and query results may be stored in a dataset accessed and controlled by the query manager 130. In the example of FIG. 1, the dataset is configured as a view definition store 132. In other embodiments, the dataset in which such query history data is stored may be integrated with any one or more of the other datasets in the memories 108, such as the code index dataset 110.

The design data in the code index dataset 110 may include design annotations. In some embodiments, query results may be used to specify the design annotations. For example, design annotations may define layers of the software system 102, and each layer may be defined via a respective dataset query. More generally, the design annotations may be specified and provided to the code index dataset 110 via an annotation interpreter module 134. The annotation interpreter module 134 may receive an expression and/or other data of a design annotation via a user interface, such as a text editor, dedicated to creating the design annotations. The creation of the design annotations via the user interface may include specifying a name or other information for the design annotation and specifying a definition to determine to or with which code elements or artifacts the design annotation is applied or associated. As shown in the examples below, the user interface may also allow an annotation type and an annotation scope to be specified. Example annotation types include layers, dependency relationships, inheritance relationships, association relationships, components, contracts, supplier-contract-client relationships, and other concepts used in an abstraction or stored about the code in the code index dataset 110. Annotations may thus refer to elements in the code, in abstractions derived from the code or other annotations. The complexity of the references may vary (e.g., the source of a dependency relationship is namespace A, or the code represented by this layer is the result of running this specific query). Annotation scopes may specify whether the design annotation is globally or permanently applied to the code elements (e.g., for use in future dataset queries) or locally or temporarily applied (e.g., for use only within the current design representation view). Annotations may express statements about the code or statements about a desired future state of the code, such as marking features to be deleted, added, or modified.

In some embodiments, design annotations may be specified via the text editor or other user interface rendered for specifying dataset queries. The design annotations may thus be generated automatically. For example, the creation of design annotations may be implemented in an overlay or other user interface element integrated into the user interface(s) rendered for dataset queries and the results thereof. The design annotations may thus be associated with code elements or artifacts returned as a result of a query. Once the design annotations are generated via the query, the user interface may allow the design annotations to be edited or removed.

The design annotations may be specified using an annotation language or syntax. The annotation interpreter module 134 may be configured to parse and process the definition and other information entered via the user interface in accordance with the annotation syntax. For example, the processing may include evaluating each term of the parsed definition and implementing any functions or operators set forth in the definition.

Design annotations may reference elements in the code, or other design annotations. Detailed design information may thus be expressed. The references may be made directly or through a query. For example, a design annotation may be specified for a specific layer that groups the set of code elements returned by a respective query.

One or more of the design annotations may be designated as indicative of a design rule of an expected or desired design model of the software system 102. Such design annotations may be referred to as policy annotations. The designation may be facilitated via the user interface through which design annotations are defined. For example, the scope of the design annotation may be changed to a “desired” scope, as shown in the examples described below.

Data indicative of each policy annotation may be stored in a dedicated dataset. In this example, the policy annotations are persisted in a policy annotated store 136. The policy annotations may alternatively be integrated with data stored in the code index dataset 110 or other component of the memories 108.

The policy annotations may be used by a policy evaluation module 140 configured to evaluate the software system 102 to identify any violations or errors. The policy evaluation module 140 may include validation instructions to configure the processor to implement a validation procedure over the subset of the dataset based on the design annotation data. The results of the validation procedure, including any validation errors, may be viewed through a log file or user interface generated by the presentation module 128. The presentation module 128 may be configured to render the results of the validation procedure in the view of the design representation. For example, the results may be indicated via an overlay on a diagrammatic representation view of the software system 102. Errors may be highlighted as shown in the examples described below.

The use of policy annotations and design representation views may be used to validate actual designs against expected designs. The design representation view defines the scope of the validation procedure. The subset of the code index dataset 110 identified via a query, in turn, identifies the code elements and other design data to be validated against the expected model.

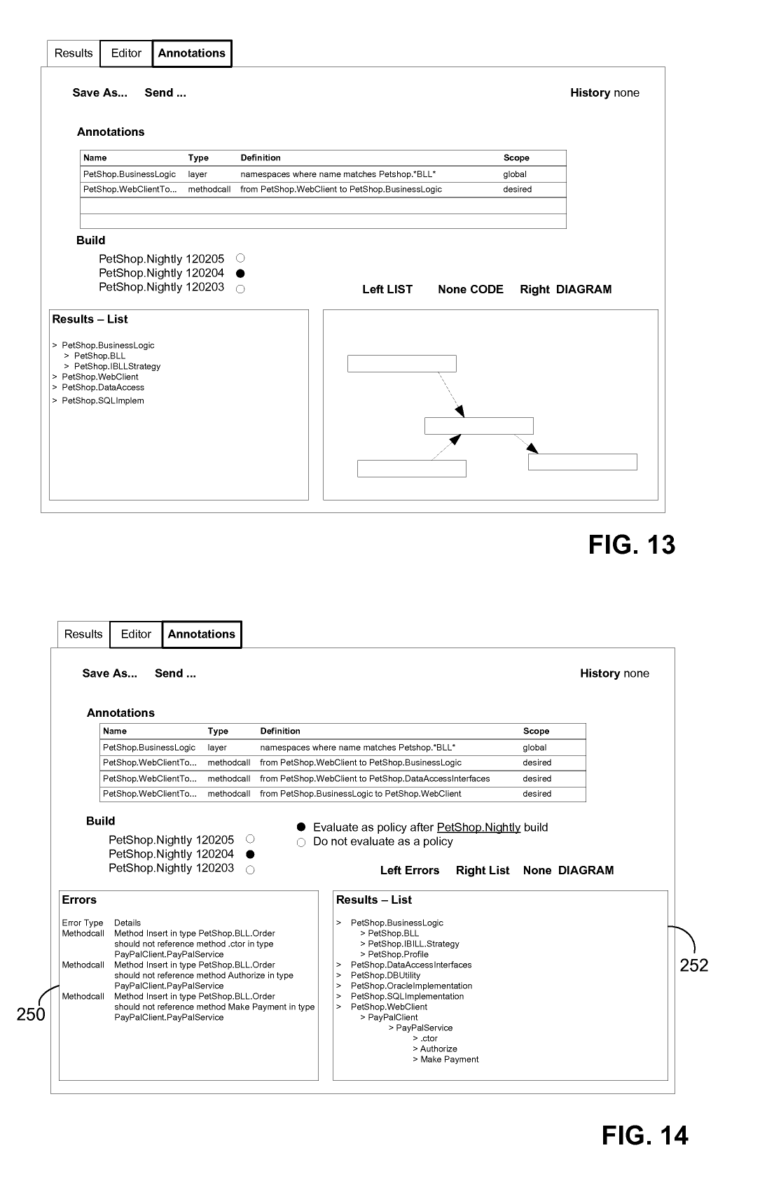

The use of design annotations may facilitate the identification of the details of the expected design. In some cases, policy annotations may rely on information already in the code. For example, if namespaces provide an adequate layering mechanism, then layers need not be specified via annotations that are effectively copies of the namespaces to express that fact that there should not be a dependency between two layers. Instead, a single policy annotation may suffice. Further details are provided below in connection with the embodiment depicted in FIG. 13, in which method call annotations are specified between layers.

The system 100 distinguishes between code elements, policy annotations, and other design annotations, such as those design annotations that provide missing design information. Distinguishing between these types of design data may facilitate the creation of visualizations that depict actual and expected design states concurrently.

The instructions stored in the memories may configure the processor 104 to obtain performance data for the software system 102. Performance data may be obtained for the software code elements in the subset of a particular design representation view. In one embodiment, the presentation module 128 is configured to obtain the performance data and incorporate a representation of the performance data into the view as an overlay. Alternatively or additionally, the performance and design data may be provided in other formats via a query result export module 142. Examples of performance data user interface overlays and data exports are described below.

The system 100 may be extensible or modifiable in a number of ways. Additional or modified instructions may be imported into the memories 108 via a number of plug-in managers or utilities. The instructions may be configured to relate to additional programming languages, frameworks, or schemes, or modifications of a current programming language or scheme. The system 100 is thus not limited to use with, for instance, a single framework, such as the .NET framework. In the example of FIG. 1, the modules are separately extensible. Information may be provided via the schema import module 118 and the plug-in manager 124 for the abstraction function module 122. Additions or modifications to the query language may be imported via a plug-in manager 144 for the query interpreter module 126. For example, one or more view or query handlers may be imported via the plug-in manager 144 to enable the dataset query language to handle and support properties or items incorporated into the design data via the abstraction function module 122.

Additions or modifications to the annotation language may be imported via a plug-in manager 146. With the query interpreter module 126 and the annotation interpreter module 134 pluggable or otherwise extensible, new kinds of views and annotations may be constructed as new programming languages, technologies, and abstraction functions are incorporated into the code index dataset 110. The code element load module 116 may also be updated via a plug-in manager 148 to support additional source code languages or types of code artifacts. The load process of the system 100 may thus be pluggable or otherwise extensible. Alternatively, instructions may be imported and stored in the memories 108 via an import module configured to import software design constructs across multiple modules.

The architecture of the modules may differ from the example shown. For example, each module may include multiple modules to support different schema, such as different programming languages. Multiple modules may be included to support different abstraction functions.

In operation, the processor 104 may be configured via the above-described system modules to provide views and other design representations of selected subsets, or slices, of the software system 102. The subsets may be defined via queries specifying various combinations of code element names and other properties, including properties added via the system 100, such as design annotations and design abstractions. The design representation views may present the design data results from the queries, including lists, diagrams, and other representations of code elements, design annotations, and design abstractions. The design representation views may be refreshed by re-implementing the dataset queries. The design representation views may be updated to reflect changes to the code elements or design annotations. The design representation views may thus provide living or current design documentation of the software system 102.

The design representation views need not be static, but instead be part of user interfaces having links or other user options to explore the underlying code. The user interfaces may also include other live or current information via overlays or other user interface elements for performance data of the associated code elements, such as code coverage, bug count, and other data. The user interfaces may also provide options to compare or otherwise explore how the code structures, elements or artifacts have changed over time (e.g., between selected builds). For example, semantic differences may be highlighted between different versions of a design representation view. Overlays may be used to depict how views have changed over time.

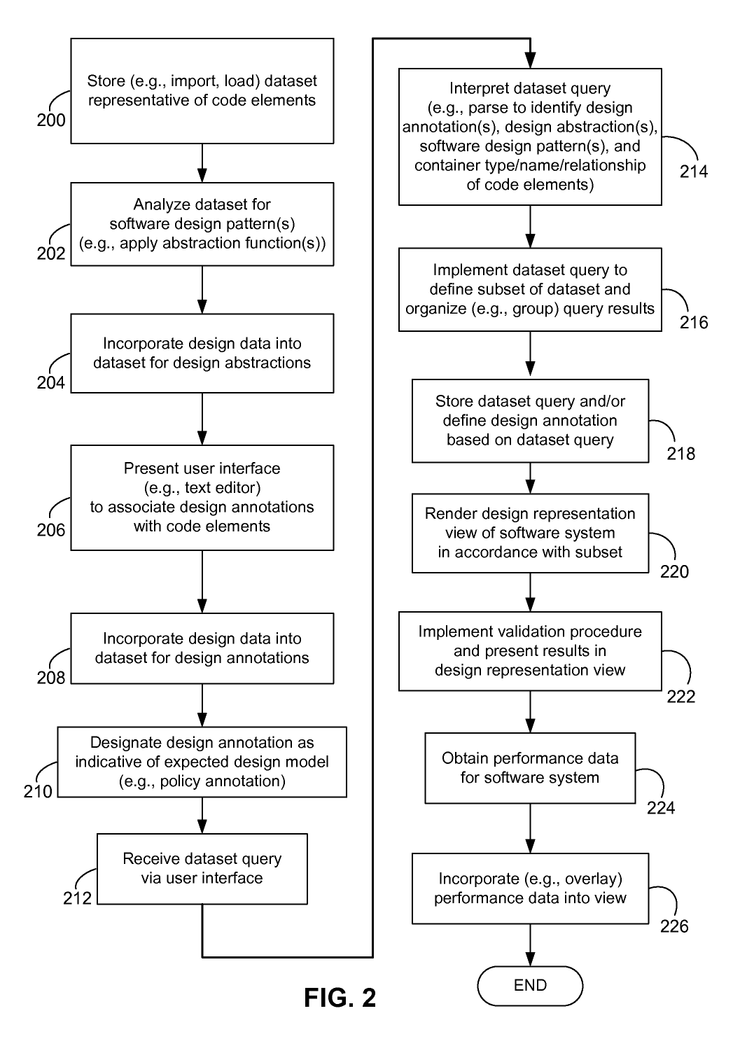

FIG. 2 depicts a method for providing a design representation of a software system in accordance with one embodiment. The method is computer-implemented. For example, the processor 104 of FIG. 1 (or any other processing unit or system) may be configured to implement one or more of the acts of the method. The implementation of each act may be directed by respective computer-readable instructions executed by the processor 104 or another processing system. The computer-readable instructions may be encoded on a computer-readable storage medium, such as one or more of the memories 108 of FIG. 1. Additional, alternative, or fewer acts may be implemented. For example, the design representations provided by the method may be generated without design annotations in the design data. The acts need not be implemented in the order shown. For example, design annotations may be defined after the presentation of query results for use of such results in automating the specification of the design annotations. In another example, the analysis for design abstractions may be implemented after one or more design annotations are incorporated into the design data. The annotations may assist the abstraction function module 122 (FIG. 1) in detecting the software design pattern.

The method may begin in act 200 with storing, in a memory or computer-readable storage medium, a dataset representative of a plurality of software code elements of a software system. The software code elements may be source code or code artifacts. The software code elements may imported or loaded into the dataset directly or transformed before being stored in the dataset.

The act 200 may include storing design data into the dataset other than the data representative of the source code or code artifacts. The design data is representative of respective design properties of the software code elements. Examples of such design data include design annotations or design abstractions, as described above. However, in the example shown in FIG. 2, such design data is incorporated into the dataset subsequently as described below.

Once the data representative of the code elements or artifacts is available in the dataset, further design data may be generated based on analysis and other automated processing and use of such data. In act 202, the dataset is analyzed for an instance of one or more software design patterns. The software design patterns may be detected by applying a software design abstraction function to the plurality of software code elements. The resulting design data may be configured such that the respective design properties of the respective software code elements of the instance are indicative of corresponding design abstractions of the software design pattern. Such design data may be incorporated in act 204. In some cases, the design data may be incorporated into the dataset by associating each software code element of the instance with a corresponding design abstraction of the software design pattern.

A user interface may be presented in act 206 via an output device to facilitate the association of one or more design annotations with one or more of the plurality of software code elements. The user interface may include a number of user input elements (e.g., tables or other data entry fields) configured to support the naming and definition of the design annotations. For example, the user interface may include a text editor for entry of an expression specifying the software code elements with which the design annotation is associated. The user interface may also allow a user to specify other aspects of each design annotation, such as a type (e.g., layer or method call) and a scope (e.g., local, global, or desired). Once the definition and other aspects of the design annotations have been entered or specified, design data indicative of or in accordance with the design annotation is incorporated in act 208 into the dataset.

At any time during the definition or incorporation of the design annotations, any one or more of the design annotations defined via the user interface may be designated in act 210 as a policy annotation or otherwise indicative of an expected design model of the software system. The user interface may be used to implement the designation. In one example, the scope property or aspect of the design annotation may be used for the designation, as described above.

With design data available in the dataset, a dataset query may be received in act 212 via the user interface. The dataset query is specified via an expression that may include any number of references to design annotations, software design patterns, design abstractions of the software design pattern, or other item of the design data, such as a container type, an object name, or an object relationship of the plurality of software code elements. Examples of dataset queries combining references to these items of the design data are set forth in connection with FIGS. 3-6.

In act 214, the dataset query is interpreted. An interpretation procedure may be implemented in accordance with a query language or syntax. The interpretation procedure may include parsing an expression entered via the user interface to identify the items of design data specified in the expression, such as design annotations, design abstractions, software design patterns, and container types, names, and relationships. The parsing of the expression may also identify operators and other terms of the dataset query. The operators may be used to logically combine or otherwise act upon the items of design data. Alternatively or additionally, the operators may be used to organize results of the dataset query for the view of the design representation. For example, the results may be organized in groups specified in the dataset query.

Once the dataset query is interpreted, the dataset query may be implemented in act 216. The implementation may include implementing one or more database queries over the dataset. The implementation of the dataset query defines a subset of the dataset based on the reference(s) to the item(s) of the design data, as described above. Data indicative of the dataset query and/or the query results may be stored in act 218. Storage of the dataset query or the query results may include defining a design annotation. For example, the user interface may provide an option to associate each result of the dataset query with a design annotation.

A view or design representation of the software system may be rendered at any time after the interpretation and implementation of the dataset query. In this example, a design representation view is rendered in act 220. The design representation view presents information regarding the subset of the dataset returned by the dataset query. For example, the design representation view may include a list of the respective software code elements of the plurality of software code elements in the subset defined via the dataset query. As shown in the example of FIG. 3, the design representation view may also include a depiction of an excerpt of the source code underlying a selected one of the respective software code elements.

In the embodiment shown in FIG. 2, the method also includes a number of additional procedures that may present information about the software system in conjunction with the results of the dataset query. The view of the design representation may thus be enhanced or augmented by such additional information. In act 222, a validation procedure is implemented, the results of which are presented in the design representation view. The validation procedure may be based on a design annotation indicative of an expected or desired design rule as described above. The validation procedure may be triggered manually or automatically (e.g., after each build of the software system).

In acts 224 and 226, performance data is obtained for the software system and incorporated into the design representation view. In each procedure, the additional information may be presented as an overlay to the design representation view. For example, errors returned by the validation procedure may be indicated by a certain color or other highlighting in a diagrammatic view of the design representation. The scope of each procedure (and accordingly the overlay) is established via the subset of the dataset defined via the dataset query.

FIGS. 3 through 14 provide a number of examples of user interfaces rendered or generated by the disclosed methods and systems. The user interfaces illustrate the use of dataset queries to provide design representations of a software system. In each example, the dataset queries and design annotations are expressed via a textual syntax. The nature of the textual syntax may vary from the examples shown. In other embodiments, the dataset queries and other items of design data may be set forth and defined non-textually (e.g., via a series of graphical elements).

The user interfaces rendered by the disclosed methods and systems need not share a common framework as shown in the examples. The disclosed methods and systems are not limited to a user experience having a single integrated user interface. The manner in which the user may navigate or access the user interfaces may vary from the examples shown, and need not involve tabs. Within each user interface, any number of aspects of the rendering of the design representation views may vary from the examples shown. For example, the rendering may vary based on the type of output device (e.g., tablet or monitor) and/or the type of user input device(s) (e.g., pointer, stylus, or touchscreen).

FIG. 3 depicts an editor user interface that provides an exemplary dataset query, the results of which return a design representation view having a set of methods. The dataset query is set forth in a text entry box 230 and the design representation view is presented in a results panel 232 that shows the results as a list of code elements to which the dataset query applies. In this example, the resulting view of the design representation shows all methods having a name that contains or includes the string “payment.” Two example operators of the query language, “where” and “contains,” are highlighted. Selection of one of the listed code elements reveals the underlying source code in a results panel 234. The user may be allowed to navigate through the source code via scroll bars and other user interface elements. The underlying source code may be obtained in a variety of ways, including, for instance, by accessing program database (PDB) files. The user interface also allows the build of the software system over which the dataset query is run to be selected. The user interface also provides the user with options to store or send the dataset query and resulting design representation view, as well as access a history of saved queries.

FIG. 4 depicts the editor user interface with another exemplary dataset query entered into the text entry box 230. In this example, the dataset query is directed to a view of the subset of methods corresponding with the union of methods whose name contains the string “wzdCheckOut_FinishButtonClick” and any methods called by those methods. The query then includes an instruction to group the results by type. The results panel 232 accordingly presents a list of code elements grouped by type. In this example, the user has selected that the results panel 234 present the results visualized as a diagram (e.g., a UML diagram). The diagram may also present the results grouped by type. Each element in the diagram may be selected to expand the element to view methods or other code elements of the respective type. In some embodiments, the types may correspond with the types in the .NET framework, such as classes, structures, enumerations, interfaces, and delegates.

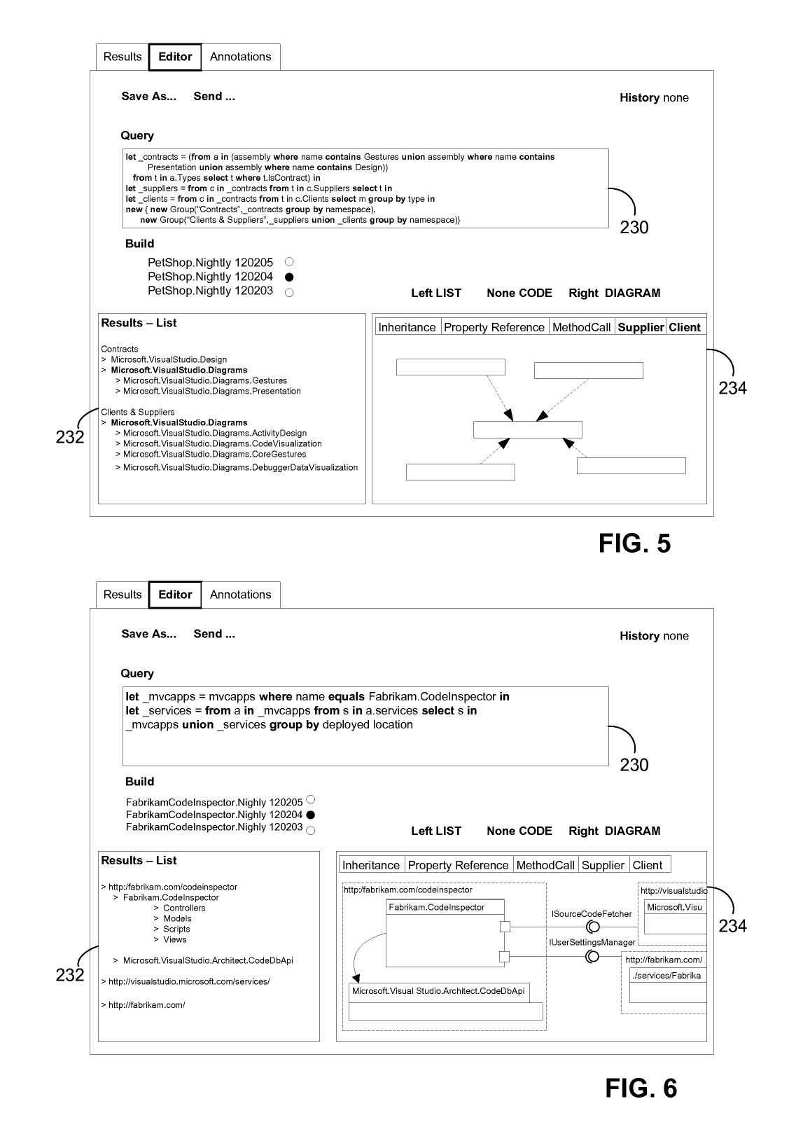

FIG. 5 depicts the editor user interface with another exemplary dataset query entered into the text entry box 230. The dataset query provides a view with design abstraction information for the code elements. In this example, the design abstractions correspond with the contracts, clients, and suppliers from a dependency injection pattern. The query returns contracts, clients, and suppliers from a set of assemblies. The contracts, clients, and suppliers of the dependency injection pattern are detected by a corresponding abstraction function configured to look for dependency injection patterns in code written against dependency injection frameworks, such as MEF or Ninject. Implementation of the abstraction function adds properties (e.g., a type as “contract”) to the code elements corresponding with the respective design abstractions of the pattern. The diagrammatic view provided by the results panel 234 provides information regarding the abstraction relationships. The query in this example also illustrates how the groups in the results may be labeled (e.g., labeled groups of namespaces).

FIG. 6 depicts the editor user interface with an exemplary dataset query in the text entry box 230 for another view with design abstraction information. In this example, the patterns previously observed in the code elements involve a model-view-controller (MVC) application and services. The query is directed to showing the MVC application and the web services used by the application. Unlike the previous example in which classes in the code elements are being labeled, the query language allows the query to introduce two temporary variables, _mvcapps and _services, which carry interim results that may then be combined into a final result for depiction in the results panels 232 and 234. In this example, a Fabrikam.Codelnspector application is selected, together with all of its services, for display in groups by “deployed location.”

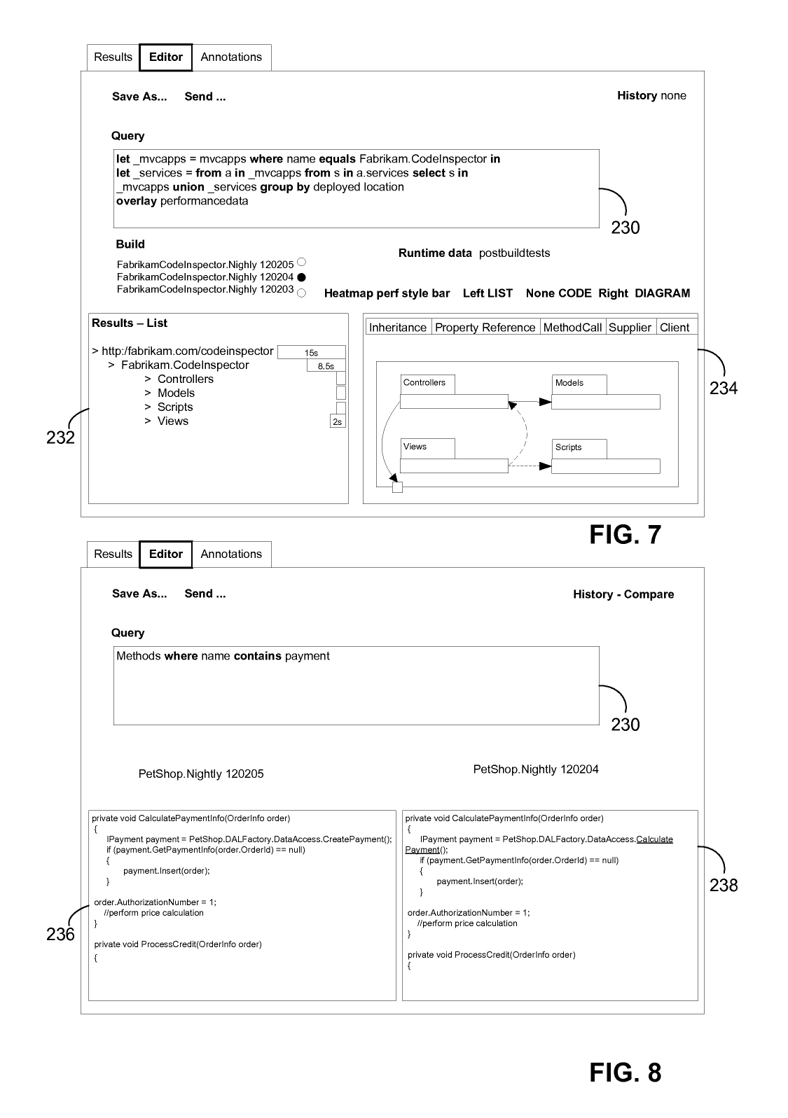

FIG. 7 depicts the user interface of FIG. 6 with performance data overlaid on the views of the code elements. In this example, the performance data overlay is triggered via an instruction specified in the text entry box 230. The results panel 232 presents the performance data in a bar style graph. The code elements may be colored in the results panels 232, 234 as in a heat map to depict varying levels of performance. The manner in which the performance data is presented may vary, and the user interface may provide options for selection by a user.

FIG. 8 depicts the editor user interface with a historical comparison of the views resulting from the dataset query of FIG. 3. Selection of the historical comparison option (e.g., “History-Compare”) by the user directs the system to provide results panels 236 and 238 for a side-by-side comparison of two selected builds of the software system. In this example, the view presents the underlying code calculated against different builds of the software system. The results panels 236 and 238 may alternatively provide other views of the different builds as shown in the examples described above.

The user interface may present other historical viewing options. For example, instead of a comparison, the historical views may be presented in a trend view to depict performance data over a number of builds. The user interface may include the elements shown in FIG. 7 in combination with a slider or other user interface element for selection of a build. Use of the slider may help a user explore how the performance data changes over time. The user interface may also provide the user with the option of exporting the performance data to a spreadsheet.

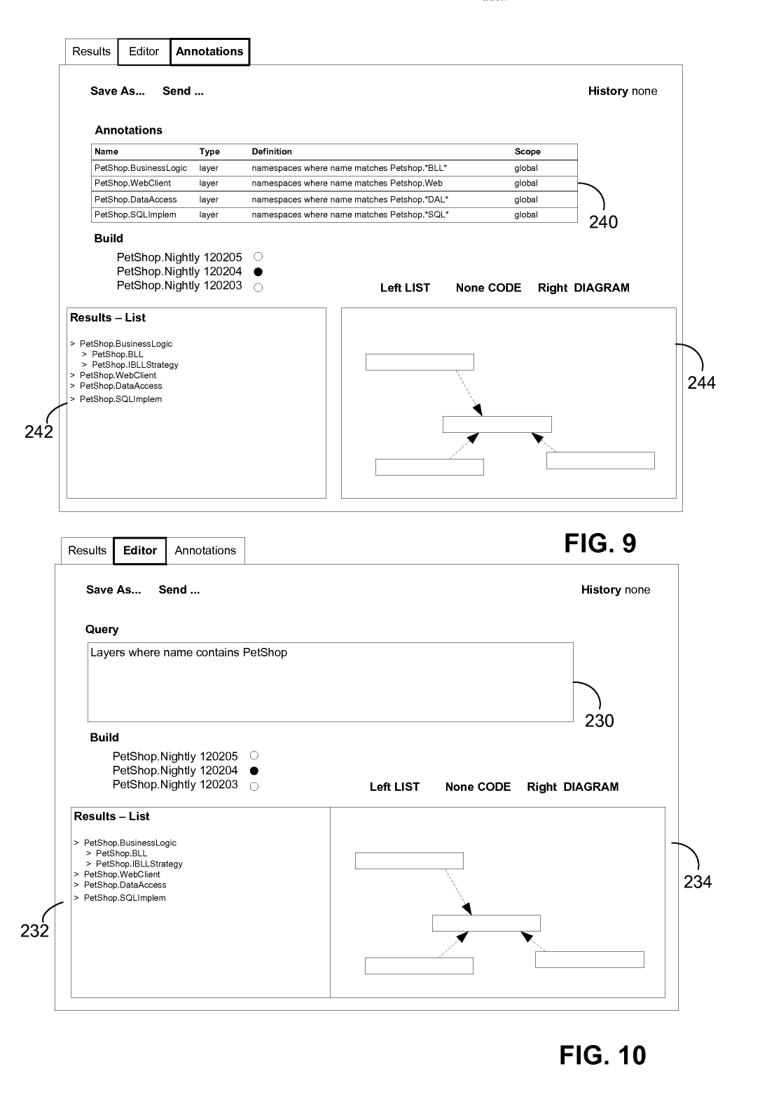

FIG. 9 depicts an exemplary user interface for defining design annotations. In this example, the design annotations are specified to define layers for the software system, where each layer is defined by a query over the code. The names and definitions of each design annotation are specified in a text entry box 240. The text entry box 240 provides an option to designate a type (e.g., layer) and a scope of each design annotation. In this example, each annotation is defined to be global, rather than local to the query (or rather than a policy annotation). The code elements associated with the design annotations may be shown in results panels 242 and 244. Because the layer design annotations are defined to be global, the design annotations may appear as part of the results of other queries, such as one having the following expression: “methods where name contains payment group by type by namespace by layer.”

FIG. 10 depicts how the annotations defined in the user interface of FIG. 9 may be used in a subsequent dataset query. The query returns the set of layer annotations in this example.

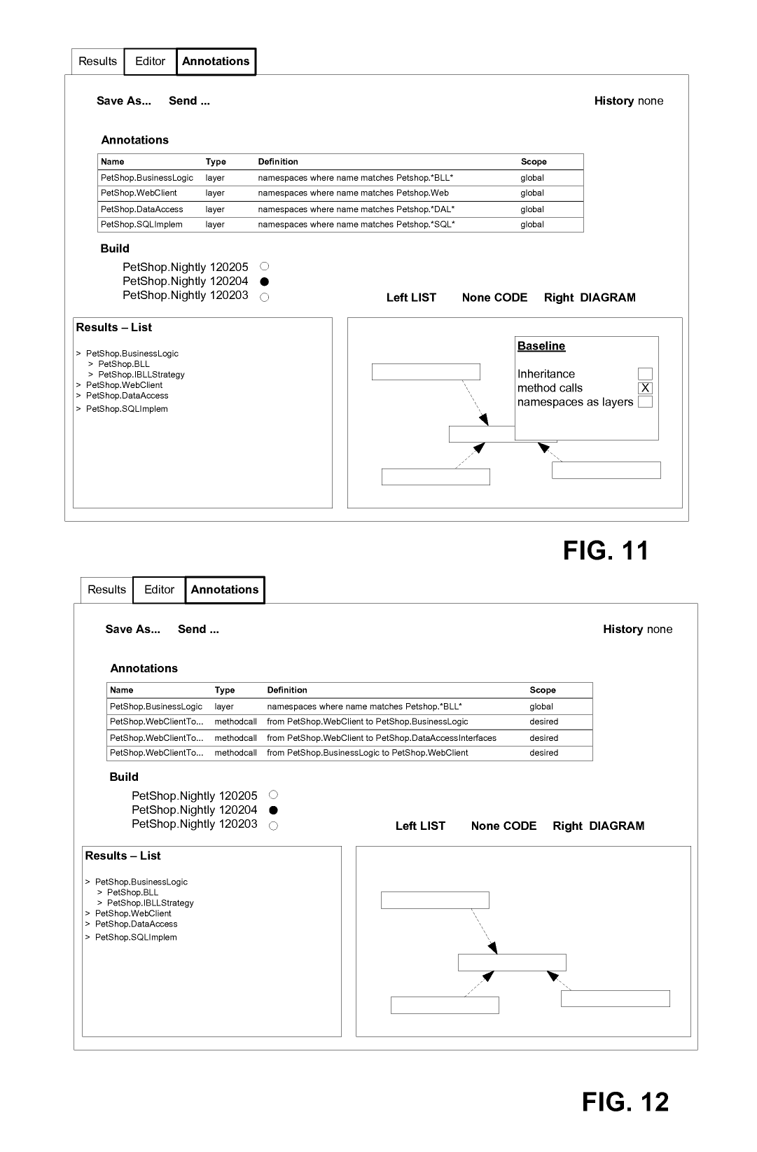

FIGS. 11-13 depict various techniques in which design annotations may be generated automatically, rather than individually and manually entered by a user. In one technique, a user may create a set of annotations that capture a baseline based on the actual code. A baseline may be indicative of a desired state of the software system. Certain constructs may be baselined via annotations. In this example, aggregated method call relationships between layers are baselined, where a relationship between layers is an aggregation of the method call relationships between methods in classes in those layers. A set of method call annotations is thus created matching the actual method call relationships obtained from the code. Once the annotations are created, the annotations can be edited, deleted and specified as part of a desired design, as shown in FIG. 12. In the example of FIG. 13, two method call relationships are deleted to indicate that there should not be any method calls from BusinessLogic to WebClient layers and from WebClient to DataAccesslnterface layers. As a result, the relationships shown in the diagram may be highlighted (e.g., via a different line type) to indicate that the relationships violate the desired method call model.

FIG. 14 depicts an exemplary user interface in which a view with desired annotations is marked as being a policy to be evaluated. The user interface may provide an option to select that the evaluation occur after, for example, every build. When evaluated, policy violation information is generated in a results panel 250. A results panel 252 is provided to allow the user to navigate from code elements identified in the results panel 250 to the location in the view (or code) where the errors occur. The user interface may support various techniques for navigating from errors to code, highlighting violations in code, and filtering the view only to show violations.

A variety of different design abstractions and other constructs may be revealed in the code elements. The disclosed methods and systems are not limited to the annotation, layer and method call examples described above. Any construct or abstraction that may be discovered from code may be associated with a corresponding annotation by the disclosed methods and systems.

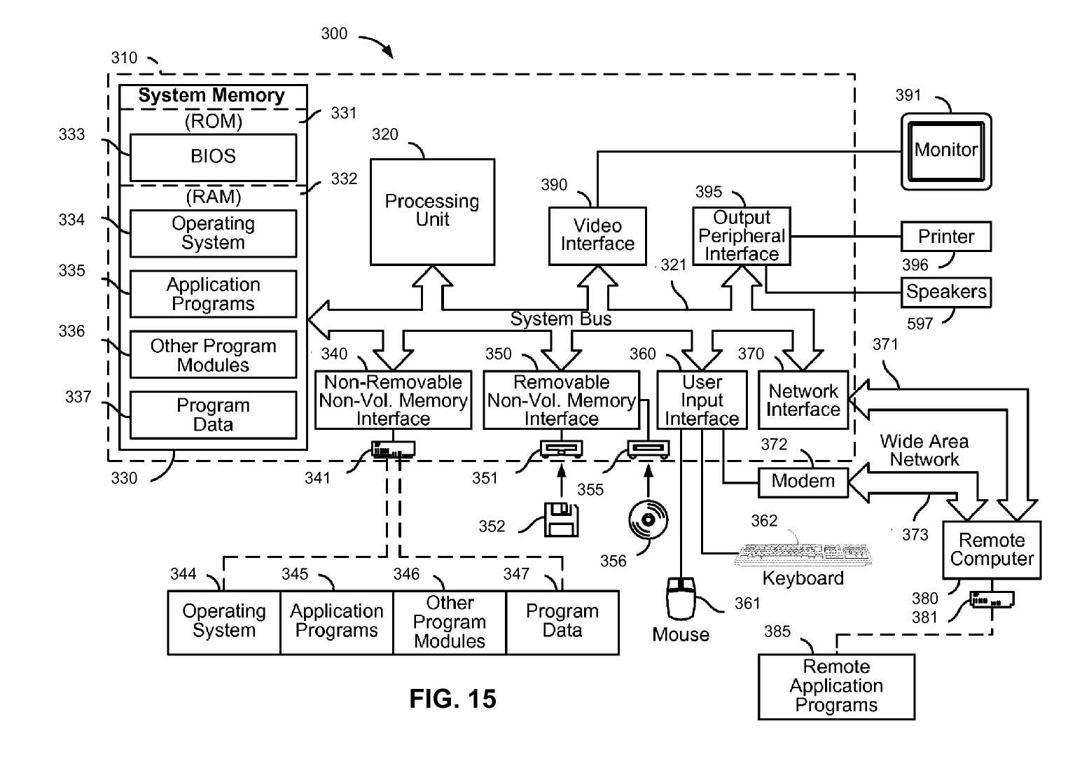

With reference to FIG. 15, an exemplary computing environment 300 may be used to implement one or more aspects or elements of the above-described methods and/or systems. For example, the computing environment of FIG. 15 may be used by, or incorporated into, or correspond with one or more elements of the system 100 (FIG. 1), such as the processor 104 (FIG. 1), and one or more of the memories 108 (FIG. 1). In each case, the computing environment of FIG. 15 may be used or included as a client, network server, application server, or database management system or other data store manager, of any of the aforementioned elements or system components.

The computing environment 500 includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The units, components, and other hardware of computer 310 may vary from the example shown.

Computer 310 typically includes a variety of computer readable storage media configured to store instructions and other data. Such computer readable storage media may be any available media that may be accessed by computer 310 and includes both volatile and nonvolatile media, removable and non-removable media. By way of example, and not limitation, such computer readable storage media may include computer storage media as distinguished from communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by computer 310.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 15 illustrates operating system 334, application programs 335, other program modules 336, and program data 337. For example, one or more of the application programs 335 may be directed to implementing the abstraction function module 122 (FIG. 1), the query interpreter module 126 (FIG. 1), or the annotation interpreter module 134 (FIG. 1). Alternatively or additionally, one or more components of the system 100, such as the presentation module 128 (FIG. 1) or the query result export module 142 (FIG. 1), may be implemented via one or more of the other program modules 336. In this or another example, the code index dataset 110 (FIG. 1), the view definition store 132 (FIG. 1), or the policy annotation store 136 (FIG. 1) may be stored as program data 337.

Any one or more of the operating system 334, the application programs 335, the other program modules 336, and the program data 337 may be stored on, and implemented via, a system on a chip (SOC). Any of the above-described modules may be implemented via one or more SOC devices. The extent to which the above-described modules are integrated in a SOC or other device may vary.

The computer 310 may also include other removable/non-removable, volatile/nonvolatile computer storage media. By way of example only, FIG. 15 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 15, provide storage of computer readable instructions, data structures, program modules and other data for the computer 310. In FIG. 15, for example, hard disk drive 341 is illustrated as storing operating system 344, application programs 345, other program modules 346, and program data 347. These components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball or touch pad. Other input devices (not shown) may include a microphone (e.g., for voice control), touchscreen (e.g., for touch-based gestures and other movements), ranger sensor or other camera (e.g., for gestures and other movements), joystick, game pad, and scanner. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 15. The logical connections depicted in FIG. 15 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 15 illustrates remote application programs 385 as residing on memory device 381. It will be appreciated that the network connections shown are exemplary and other means of establishing a communications link between the computers may be used.

The computing environment 300 of FIG. 15 is only one example of a suitable computing environment and is not intended to suggest any limitation as to the scope of use or functionality of the technology herein. Neither should the computing environment 300 be interpreted as having any dependency or requirement relating to any one or combination of components illustrated in the exemplary operating environment 300.

The technology described herein is operational with numerous other general purpose or special purpose computing system environments or configurations. Examples of well-known computing systems, environments, and/or configurations that may be suitable for use with the technology herein include, but are not limited to, personal computers, server computers (including server-client architectures), hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A computer-implemented method for providing a design representation of a software system, the computer-implemented method comprising:
storing in a memory a dataset representative of a plurality of software code elements of the software system, wherein storing the dataset comprises incorporating design data into the dataset, the design data being representative of respective design properties regarding the software code elements;
receiving a dataset query comprising a reference to an item of the dataset;
implementing, with a processing unit in communication with the memory, the dataset query over the dataset, wherein implementing the dataset query comprises defining a subset of the dataset based on the reference to the item; and
rendering, via an output device in communication with the processing unit, a user interface comprising a view of the design representation of the software system in accordance with the defined subset of the dataset.

2. The computer-implemented method of claim 1, wherein incorporating the design data comprises generating the design data by applying a software design abstraction function to the plurality of software code elements.

3. The computer-implemented method of claim 2, wherein applying the software design abstraction function comprises:
analyzing the dataset for an instance of a software design pattern of the software design abstraction function; and
configuring the design data such that the respective design properties of the respective software code elements of the instance are indicative of corresponding design abstractions of the software design pattern.

4. The computer-implemented method of claim 3, wherein the item referenced in the dataset query is indicative of the software design pattern or a respective one of the corresponding design abstractions of the software design pattern.

5. The computer-implemented method of claim 1, wherein the item referenced in the dataset query is indicative of a design annotation associated with one or more software code elements of the plurality of software code elements.

6. The computer-implemented method of claim 5, further comprising:
receiving an indication that the design annotation is indicative of an expected model of the software system; and
implementing, with the processing unit, a validation procedure of the plurality of software code elements based on the design annotation;
wherein the subset of the dataset defines a scope of the validation procedure; and
wherein rendering the user interface comprises presenting results of the validation procedure.

7. The computer-implemented method of claim 1, wherein incorporating the design data comprises defining a design annotation for a number of the plurality of software code elements via a user input of the user interface.

8. The computer-implemented method of claim 1, wherein rendering the user interface comprises:
obtaining performance data for the software code elements in the subset;
incorporating a representation of the performance data into the view of the design representation.

9. The computer-implemented method of claim 1, wherein the reference in the dataset query is configured to specify a container type, a name, or a relationship of the plurality of software code elements.

10. The computer-implemented method of claim 1, wherein the view comprises a list of the respective software code elements of the plurality of software code elements in the subset defined via the dataset query.

11. The computer-implemented method of claim 10, wherein the view further comprises a source code excerpt underlying a selected one of the respective software code elements.

12. A system for providing a design representation of a software system, the system comprising:
a dataset memory in which a dataset representative of a plurality of software code elements of the software system is stored, the dataset comprising design data representative of respective design properties regarding the software code elements;
a system memory in which interpreter module instructions, abstraction module instructions, and presentation module instructions are stored;
a processor coupled to the system memory and the dataset memory, the processor being configured via:
the abstraction module instructions to analyze the dataset for an instance of a software design pattern and to configure the design data in the dataset to associate each software code element of the instance with a corresponding design abstraction of the software design pattern, and
the interpreter module instructions to interpret a dataset query comprising a reference to the software design pattern or the corresponding design abstraction, and to implement the dataset query over the dataset to define a subset of the dataset associated with the software design pattern or the corresponding design abstraction; and
an output device coupled to the processor, the processor being configured via the presentation module instructions to render, via the output device, a user interface comprising a view of the design representation of the software system in accordance with the defined subset of the dataset.

13. The system of claim 12, wherein the interpreter instructions are configured to interpret the dataset query to specify a container type, a name, or a relationship of the software code elements and to organize results of the dataset query for the view of the design representation.

14. The system of claim 12, wherein the presentation module instructions configure the processor to obtain performance data for the software code elements in the subset and to incorporate a representation of the performance data into the view of the design representation.

15. The system of claim 12, wherein:
the dataset comprises design annotation data associated with the software code elements and designated as indicative of an expected design model;
validation instructions are stored in the system memory to configure the processor to implement a validation procedure over the subset of the dataset based on the design annotation data; and
the presentation module instructions configure the processor to present results of the validation procedure in the view of the design representation.

16. The system of claim 12, wherein the processor is configured via import instructions stored in the system memory to import a software design construct into the interpreter module instructions or the abstraction module instructions.

17. A computer program product comprising one or more computer-readable storage media in which computer-readable instructions are stored that, when executed by a processing system, direct the processing system to:
store, in a memory, a dataset representative of a plurality of software code elements of a software system;
analyze the dataset for an instance of a software design pattern;
incorporate first design data into the dataset to associate each software code element of the instance with a corresponding design abstraction of the software design pattern;
present, via an output device, a user interface for associating a design annotation with one or more of the plurality of software code elements;
incorporate second design data into the dataset in accordance with the design annotation;
receive a dataset query via the user interface, the dataset query comprising a reference to the design annotation, the software design pattern, or the corresponding design abstraction of the software design pattern;
interpret the dataset query to implement the dataset query over the dataset to define a subset of the dataset; and
render, via the user interface, a design representation view of the software system in accordance with the defined subset of the dataset.

18. The computer program product of claim 17, wherein the computer-readable instructions further direct the processing system to interpret the dataset query to specify a container type, a name, or a relationship of the software code elements and to organize results of the dataset query for the view of the design representation.

19. The computer program product of claim 17, wherein the computer-readable instructions further direct the processing system to obtain performance data for the software code elements in the subset and to incorporate a representation of the performance data into the view of the design representation.

20. The computer program product of claim 17, wherein the computer-readable instructions further direct the processing system to:
designate the design annotation as indicative of an expected design model;
implement a validation procedure over the subset of the dataset based on the design annotation; and
present results of the validation procedure in the design representation view.
